(19) United States
(12) Patent Application Publication
(10) Pub. No.: US 2013/0237210 A1
(43) Pub. Date: Sep. 12, 2013

(54) DATA TRANSMITTING/RECEIVING APPARATUS AND METHOD FOR CONTROLLING INTERCELL INTERFERENCE IN A MOBILE COMMUNICATION SYSTEM

(71) Applicants: KOREA ADVANCED INSTITUTE OF SCIENCE AND TECHNOLOGY, (US); SAMSUNG ELECTRONICS CO., LTD, Gyeonggi-do (KR)

(72) Inventors: Myung-Gil Kang, Daejeon (KR); Wan Choi, Daejeon (KR)

(73) Assignees: KOREA ADVANCED INSTITUTE OF SCIENCE AND TECHNOLOGY, Daejeon (KR); SAMSUNG ELECTRONICS CO., LTD, Gyeonggi-do (KR)

(21) Appl. No.: 13/789,506

(22) Filed: Mar. 7, 2013

(30) Foreign Application Priority Data
Mar. 7, 2012 (KR) 10-2012-0023487

(51) Int. Cl. H04W 72/04

(52) U.S. Cl. CPC H04W 72/0426
USPC 455/422.1

(57) ABSTRACT

Data transmitting and receiving apparatus and method for control intercell interference efficiently in a mobile communication system. A mobile communication system includes distributed small base stations including a super node and two or more general nodes. Each of the general nodes processes and transmits first data for transmission, and outputs second data independent of the first data to the super node. The super node receives the second data from the respective general nodes, and processes and transmits the second data and third data for transmission.

### CROSS-REFERENCE TO RELATED APPLICATION(S) AND CLAIM OF PRIORITY

The present application is related to and claims priority under 35 U.S.C. §119 to an application filed in the Korean Intellectual Property Office on Mar. 7, 2012 and assigned Serial No. 10-2012-0023487, the contents of which are incorporated herein by reference.

### TECHNICAL FIELD

The present disclosure relates generally to a mobile communication system and in particular, to a technique for mitigation of an intercell interference in a mobile communication system.

### BACKGROUND

Recently, technologies of decreasing the radius of a cell have been introduced in order to provide improved performance and capability to more users in a mobile communication system. For example, there is a small size of microcell for supporting a high frequency, that is, a femtocell or a picocell which is mounted within a building or a personal area and provides high transmission rate to specific users.

In addition, techniques of improving the performance of a system while also decreasing the radius of a cell have been introduced. For example, there are a wireless relay mounted in a cell boundary area in order to increase the coverage of a base station, CoMP (Coordinated MultiPoint) of improving the performance of a user terminal located at a cell boundary area using cooperative transmission of neighboring base stations, a Virtual Cellular Network (VCN) of generating a virtual cell adaptively to provide services in order to maximize frequency usage efficiency in an environment where multiple cells have different user/traffic/interference characteristics.

As various cells having a small service area have been introduced, a cell overlapping area, which is substantially affected by an intercell interference, increases, so that a technique of controlling an intercell interference become necessary in order to increase the data efficiency of a system.

As techniques for control of an intercell interference, there are an interference channel scheme, a Multi-Input Multi-Output Broadcast Channel (hereinafter referred to as ‘MIMO BC’) scheme, or the like in a VCN environment where distributed small base stations included in a virtual cell share information with each other. The MIMO BC scheme has been evaluated as the most efficient technique for control of an intercell interference, but it is required to deliver information for full cooperation of base stations, thereby causing an overload problem due to information delivery for full cooperation. Therefore, there is need for a technique of controlling an intercell interference efficiently while base stations partially cooperate with each other without causing the overload problem.

### SUMMARY

To address the above-discussed deficiencies of the prior art, it is a primary object to provide a data transmitting/receiving apparatus and method for controlling an intercell interference efficiently in a mobile communication system.

Embodiments of the present disclosure a data transmitting/receiving apparatus and method for controlling an intercell interference efficiently while base stations partially cooperate with each other through exchange of a little information in a mobile communication system including distributed small base stations.

According to an embodiment of the present disclosure, a base station apparatus for a mobile communication system includes: distributed small base stations including a super node, and two or more general nodes, wherein each of the general nodes processes and transmits first data for transmission, and outputs second data independent of the first data to the super node, and the super node receives the second data from the respective general nodes, and processes and transmits the second data and third data for transmission.

According to another embodiment of the present disclosure, a mobile terminal apparatus for a mobile communication system including distributed small base stations including a super node and two or more general nodes, includes: a signal dimension for reconstructing a signal based on data received from a corresponding node; and an interference dimension for processing data received from other nodes than the corresponding node as an interference, wherein the data received from the super node includes second data independent of first data transmitted by the respective general nodes, and third data transmitted by the super node.

According to another embodiment of the present disclosure, a method for receiving data in a terminal for a mobile communication system including distributed small base stations including a super node, and two or more general nodes, includes: reconstructing a signal based on data received from a corresponding node in a first dimension; and processing data received from other nodes than the corresponding node as an interference in a second dimension different from the first dimension, wherein the data received from the super node includes second data independent of first data transmitted by the respective general nodes, and third data transmitted by the super node.

According to another embodiment of the present disclosure, base station apparatus for a mobile communication system, and two or more general nodes, includes distributed small base stations including a super node and two or more general nodes, wherein each of the general nodes processes and transmits first data for transmission and outputs the first data and second data independent of the first data to the super node, and the super node processes and transmits the first data received from the respective general nodes in a first dimension, and processes and transmits a result of the encoding of the second data received from the respective general nodes, a result of the encoding of the first data, and third data for transmission in a second dimension different from the first dimension.

According to another embodiment of the present disclosure, a terminal apparatus corresponding to a super node in a mobile communication system including distributed small base stations including a super node, and two or more general nodes, includes a signal dimension for reconstructing a signal based on data transmitted from the general nodes and data transmitted from a signal dimension and an interference dimension of the super node, wherein the data transmitted from the interference dimension of the super node includes first data received from the respective general nodes, and the data transmitted from the signal dimension of the super node includes the first data, second data independent of first data, and third data for transmission.

According to another embodiment of the present disclosure, a terminal apparatus corresponding to a general node in a mobile communication system including distributed small base stations including a super node, and two or more general nodes, includes: a first dimension for receiving and processing data transmitted from a corresponding general node and data transmitted from an interference dimension of the super node; and a second dimension for receiving and processing data transmitted from other general nodes than the corresponding node and data transmitted from a signal dimension of the super node, wherein the data transmitted from the interference dimension of the super node includes first data received from the respective general nodes, and the data transmitted from the signal dimension of the super node includes the first data, second data independent of first data, and third data for transmission.

According to another embodiment of the present disclosure, a method for transmitting data in a super node of a mobile communication system including distributed small base stations including a super node, and two or more general nodes, includes: receiving first data for transmission and second data independent of the first data from the general nodes; processing and transmitting the first data received from the general nodes in a first dimension; and processing and transmitting a result of the encoding of the second data received from the respective general nodes, a result of the encoding of the first data, and third data for transmission in a second dimension different from the first dimension.

According to another embodiment of the present disclosure, a method for receiving data in a terminal corresponding to a super node of a mobile communication system including distributed small base stations including a super node, and two or more general nodes, includes: receiving data transmitted from the general nodes; receiving data transmitted from a signal dimension and an interference dimension of a super node; and reconstructing a signal based on the received, wherein the data transmitted from the interference dimension of the super node includes first data received from the respective general nodes, and the data transmitted from signal dimension of the super node includes the first data, second data independent of first data, and third data for transmission.

According to another embodiment of the present disclosure, a method for receiving data in a terminal corresponding to a general node of a mobile communication system including distributed small base stations including a super node, and two or more general nodes, includes: receiving and processing data transmitted from a corresponding general node and data transmitted from an interference dimension of the super node in a first dimension; and receiving and processing data transmitted from other general nodes than the corresponding general node and data transmitted from an signal dimension of the super node in a second dimension different from the first dimension, wherein the data transmitted from the interference dimension of the super node includes a first data received from the respective general nodes, and the data transmitted from the signal dimension of the super node includes the first data, second data independent of first data, and third data for transmission.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a configuration of a mobile communication system to which embodiments of the present disclosure are applicable;

FIG. 2 illustrates the principle of interference alignment used in embodiments of the present disclosure;

FIG. 3 illustrates the principle of rate-splitting encoding used in embodiments of the present disclosure;

FIG. 4 illustrates a flowchart of a processing data transmitting/receiving operation according to an embodiment of the present disclosure;

FIG. 5 illustrates a configuration of the general node-base station 100 illustrated in FIG. 4 concretely;

FIG. 6 illustrates a configuration of the general node-base station 200 illustrated in FIG. 4 concretely;

FIG. 7 illustrates a configuration of the super node-base station 300 illustrated in FIG. 4 concretely;

FIG. 8 illustrates a configuration of the mobile terminal 400 corresponding to the general node-base station 100 illustrated in FIG. 4 concretely;

FIG. 9 illustrates a configuration of the mobile terminal 500 corresponding to the general node-base station 200 illustrated in FIG. 4 concretely;

FIG. 10 illustrates a configuration of the mobile terminal 600 corresponding to the super node-base station 300 illustrated in FIG. 4 concretely;

FIG. 11 illustrates an operation for transmitting/receiving data according to an embodiment of the present disclosure;

FIG. 12 illustrates an operation for transmitting and receiving data in the base stations illustrated in FIG. 11;

FIG. 13 illustrates operations for receiving data in the mobile terminal MS1 400 illustrated in FIG. 11;

FIG. 14 illustrates operation for receiving data in the mobile terminal MS3 illustrated in FIG. 11;

FIG. 15 illustrates operation for receiving data in the mobile terminal MS3 illustrated in FIG. 11;

FIG. 16 illustrates a flowchart of a processing operation for transmitting and receiving data according to another embodiment of the present disclosure;

FIG. 17 illustrates a configuration of the general node-base station 100 illustrated in FIG. 16 concretely;

FIG. 18 illustrates a configuration of the general node-base station 200 illustrated in FIG. 16 concretely;

FIG. 19 illustrates a configuration of the super node-base station 300 illustrated in FIG. 16 concretely;

FIG. 20 illustrates a configuration of the mobile terminal 400 corresponding to the general node-base station 100 illustrated in FIG. 16 concretely;

FIG. 21 illustrates a configuration of the mobile terminal 500 corresponding to the general node-base station 200 illustrated in FIG. 16 concretely;

FIG. 22 illustrates a configuration of the mobile terminal 600 corresponding to the super node-base station 300 illustrated in FIG. 16 concretely;

FIG. 23 illustrates operations for transmitting and receiving data according to another embodiment of the present disclosure;

FIG. 24 illustrates operations for transmitting and receiving data in the base stations illustrated in FIG. 23;

FIG. 25 illustrates operations for receiving data in the mobile terminal MS1 illustrated in FIG. 23;

FIG. 26 illustrates operations for receiving data in the mobile terminal MS2 illustrated in FIG. 23;

FIG. 27 illustrates operations for receiving data in the mobile terminal MS3 illustrated in FIG. 23;

FIGS. 28A and 28B illustrate operations for designing an encoder for data transmission and reception operations according to another embodiment of the present disclosure; and

FIG. 29 illustrates a flowchart of processing operations for transmitting and receiving data according to an embodiment of the present disclosure.

### DETAILED DESCRIPTION

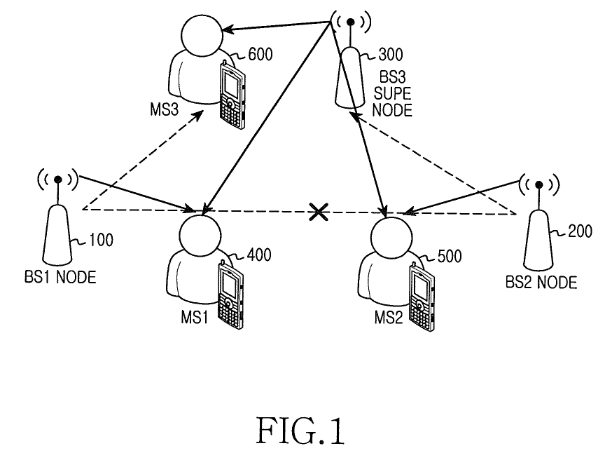

FIGS. 1 through 29, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. Exemplary embodiments of the present disclosure will be described herein below with reference to the accompanying drawings. For purposes of explanation, specific numbers, materials and configurations are set forth in order to provide a thorough understanding of the illustrative embodiments. However, it will be apparent to one skilled in the art that the present disclosure may be practiced without the specific details. Furthermore, in the following description, well-known methods, procedures, components, circuits and networks have not been described in detail.

FIG. 1 illustrates a configuration of a mobile communication system to which embodiments of the present disclosure are applicable.

FIG. 1 illustrates a configuration of a mobile communication system to which embodiments of the present disclosure are applicable. The communication system exemplarily represents a system under a Virtual Cellular Network environment (hereinafter, referred to as a “VCN system”). The VCN network includes a plurality of distributed small base stations BS1 to BS3 100, 200 and 300, and a plurality of mobile terminals MS1 to MS3 400, 500 and 600. The plurality of mobile terminals MS1 to MS3 400, 500 and 600 correspond to the plurality of distributed small base stations BS1 to BS3 100, 200 and 300 respectively. The base stations 100, 200 and 300 may be controlled by an upper macro base station. The base stations 100, 200 and 300 partially cooperate with each other. The cooperation between the base stations 100, 200 and 300 is limited according to the capability of a backhaul link, and, therefore, the base stations 100, 200 and 300 become a super node or a general node. The base station 300 is a super node which receives information from the rest base stations 100 and 200, and the base stations 100 and 200 are general nodes which have only their respective information. Herein, although it is described that the base station transmits information, the information may also be referred to as a signal, a message, data, or the like in the following description.

The backhaul link between the base station 100 and the base station 300, and the backhaul link between the base station 200 and the base station 300 can provide unidirectional cooperation. The backhaul link between the base station 100 and the base station 200 cannot provide cooperation because of limitation in its capacity. The super node-base station 300 can transmit data not only to a mobile terminal 600 corresponding to the base station 300 itself, but also to the mobile terminals 400 and 500 respectively corresponding to the general node-base stations 100 and 200 with which the base station 300 cooperates. On the other hand, the general node-base stations 100 and 200 can transmit data only to the respective corresponding mobile terminals 400 and 500.

In FIG. 1, although the VCN system in which the three base stations communicate with three mobile terminal users, and the base stations partially cooperate with each other, is exemplarily illustrated, it should be noted that the number of the base stations or the mobile terminals is not limited to 3, and embodiments of the present disclosure are not applied only to the VCM system restrictively. That is, embodiments of the present disclosure may be applicable similarly to any environment in which base stations partially cooperate with each other, besides the VCN system. For example, embodiments of the present disclosure can also be applicable to a system for supporting a two-tier heterogeneous cell structure, such as a system including a macro base station and a pico/femto base station. In such a system, the macro base station routes data to the pico/femto base station, and the macro base station and the pico/femto base station communicate with their respective mobile communication terminals based on the routed data. The macro base station may be considered as a super node because knowing data to be transmitted to the pico/femto base station in advance.

Embodiments of the present disclosure utilize a characteristic that the base stations of a VCN system partially cooperate with each other. A super node-base station transmits not only its own information, but also information received from general node-base stations which cooperate with the super node-base station. The information transmitted from the super node-base station is received in the interference dimensions of mobile teintinals corresponding to the general node-base stations. The base stations use interference alignment in order to obtain a high channel capacity in an interference channel. In addition, the base stations perform encoding operation based on a rate splitting scheme such that the mobile terminals efficiently decode a dimension in which interference alignment is performed. In particular, the super node-base station performs rate-splitting encoding on information received from the general node-base stations, and encodes a result of the rate-splitting encoding and information to be transmitted by the super-node base station itself according to an interference cancellation coding scheme and transmits the same. As a representative example of the interference cancellation coding scheme, there is a Dirty Paper Coding (DPC) (hereinafter, referred to as “DPC”) scheme. The DPC scheme is an encoding scheme in which, when previously knowing interference information, a transmitter enables a receiver not to be subjected to an interference known to the transmitter.

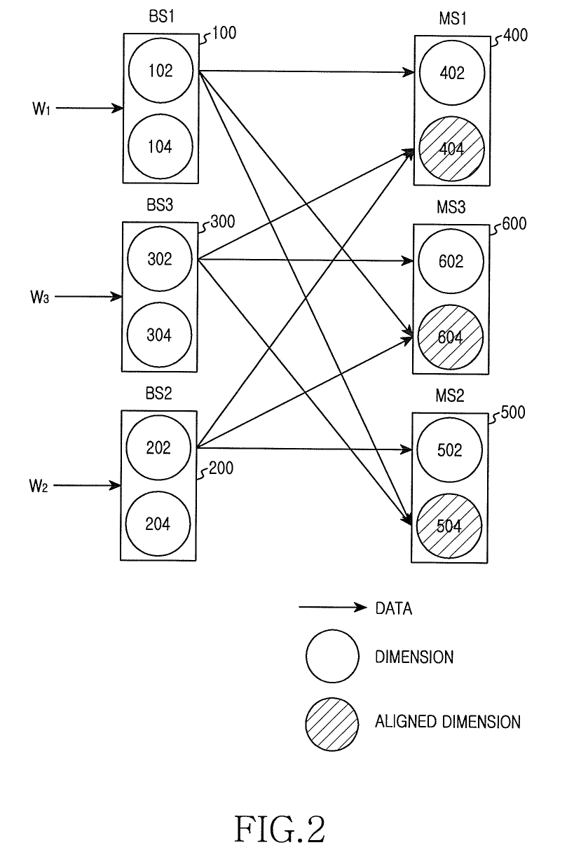

FIG. 2 illustrates the principle of interference alignment used in embodiments of the present disclosure. In an interference alignment technique, a transmitter transmits signals through beam forming, and a receiver differentiates a space occupied by interference signals from a space occupied by desired signals. The transmitter of each base station multiplies signals to be transmitted by the transmitter itself by a beam-forming matrix and transmits the same. The beam-forming matrix has to be determined such that the receiver of each mobile terminal divides its observation space into a space where the desired signal exists and a space where only an interference exists. Using the above-described method, each receiver can leave a half of its own entire reception space available to desired signals maximally. Therefore, the interference alignment technique enables half of degrees of freedom possessed by each transmitter/receiver to be used for error-free transmission of information.

In FIG. 2, a base station BS1 100 includes a signal dimension 102 and an interference dimension 104, a base station BS2 200 includes a signal dimension 202 and an interference dimension 204, and a base station BS3 300 includes a signal dimension 302 and an interference dimension 304. A mobile terminal MS1 400 includes a signal dimension 402 and an interference dimension 404, a mobile terminal MS2 500 includes a signal dimension 502 and an interference dimension 504, and a mobile terminal MS3 600 includes a signal dimension 602 and an interference dimension 604.

A signal W₁ transmitted from the base station BS1 100 is received and processed in the signal dimension 402 of the mobile terminal MS1 400 corresponding thereto, and, on the other hand, is aligned on and processed in the interference dimension 504 of the mobile terminal MS2 500 and the interference dimension 604 of the mobile terminal MS3 600. A signal W₂ transmitted from the base station BS2 200 is received and processed in the signal dimension 502 of the mobile terminal MS2 500 corresponding thereto, and, on the other hand, is aligned on and processed in the interference dimension 404 of the mobile terminal MS1 400 and the interference dimension 604 of the mobile terminal MS3 600. A signal W₃ transmitted from the base station BS3 300 is received and processed in the signal dimension 602 of the mobile terminal MS3 600 corresponding, thereto, and is aligned on and processed in the interference dimension 404 of the mobile terminal MS1 400 and the interference dimension 604 of the mobile terminal MS3 600.

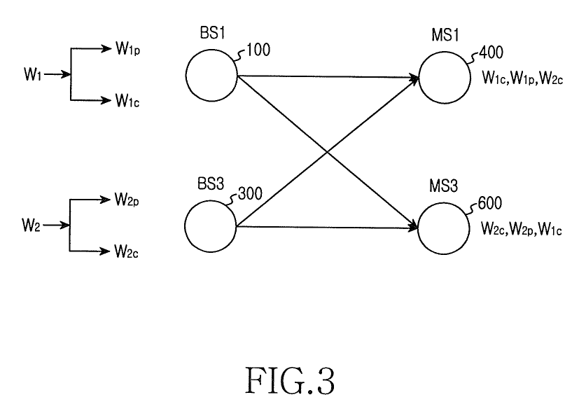

FIG. 3 illustrates the principle of rate-splitting encoding used in embodiments of the present disclosure. According to the rate-splitting encoding scheme, a transmitter splits a message to be transmitted into a common message and a private message and transmits the same. The size, rate, etc. of the common message and private message are adaptively controlled according to the intensity of channels, in particular, signal channels and interference channels between a transmitter and a receiver. The common message is a message which can be decoded by all receivers including a corresponding receiver and other receivers than the corresponding receiver. For example, the transmission rate (or transmission power) of the common message of the base station BS1 100 is controlled such that the mobile terminal MS1 400 and the mobile terminal MS3 600 can all decode the common message. Since the mobile terminal MS3 600 can decode the common message of the base station BS1 100, the mobile terminal MS3 600 can eliminate a component corresponding to the common message of the base station BS1 100 from a received signal. As described above, the common message of the base station BS1 100 is an interference with respect to the mobile terminal MS3 600, but the mobile terminal MS3 600 can eliminate the interference, thereby improving the reception quality of the mobile terminal MS3 600.

On the other hand, the private message can be decoded by a corresponding, receiver, but cannot be decoded by other receivers than the corresponding receiver. For example, the transmission rate (or transmission power) of the private message of the base station BS1 100 is controlled such that the mobile terminal MS1 400 can decode the private message, while the mobile terminal MS3 600 cannot decode the private message. The private message of the base station BS1 100 is an interference with respect to the mobile terminal MS3 600, and the mobile terminal MS3 600 decodes a message with an interference included therein. According to the rate-splitting encoding scheme, the receivers partially eliminate an interference, so that a signal-to-interference plus noise ratio or a transmission rate can be improved.

The base station BS1 100 splits a signal W₁ to be transmitted into a private message W_{1P} and a common message W_{1C} and transmits the same. The base station BS3 300 splits the signal W₂ to be transmitted into a private message W_{2P} and a common message W_{2C} and transmits the same.

The mobile terminal MS1 400 receives the signal W₁ transmitted from the base station BS1 100 and the signal W₂ transmitted from the base station BS3 300. That is, the mobile terminal MS1 400 receives W_{1P}, W_{1C}, W_{2P} and W_{2C}. W_{2P} and W_{2C} of the received signal components are an interference. In this case, the mobile terminal MS1 400 can decode W_{1C}, W_{1P} and W_{2C}, so that the mobile terminal MS1 400 can eliminate a component corresponding to W_{2C}. As a result, W_{2P} only remains as an interference with the mobile terminal MS1 400.

The mobile terminal MS3 600 receives the signal W₁ transmitted from the base station BS1 100 and the signal W₂ transmitted from the base station BS3 300. That is, the mobile terminal MS3 600 receives W_{1P}, W_{1C}, W_{2P} and W_{2C}. W_{1P} and W_{1C} of the received signal components are an interference. In this case, the mobile terminal MS3 600 can decode W_{1C}, W_{2P} and W_{2C}, so that the mobile terminal MS3 600 can eliminate e a component corresponding to W_{1C}. As a result, W_{1P} only remains as an interference with the mobile terminal MS3 600.

Embodiments of the present disclosure which will be described below are divided into two types. According to a first embodiment, general node-base stations perform rate-splitting encoding and interference alignment on information to be transmitted by the general node-base stations themselves and transmit the same. Super node-base stations perform rate-splitting encoding on information provided by the general node-base stations, and encode a result of the rate-splitting encoding and information to be transmitted by the super node-base stations themselves according to an interference cancellation coding scheme, and, thereafter, perform interference alignment on and transmit the same. In this case, the information provided by the general node-base stations is independent of information to be transmitted by the general node-base stations.

According, to a second embodiment, general node-base stations perform rate-splitting encoding and interference alignment on information to be transmitted by the general node-base stations themselves and transmit the same. Super node-base stations receive information provided by the general node-base stations and information to be transmitted, and perform rate-splitting encoding and then interference alignment on information to be transmitted by the general node-base stations through a first dimension and transmit the same. Also, the super node-base stations perform rate-splitting encoding on the information provided by the general node-base stations through a second dimension, encode a result of the rate-splitting encoding of the information to be transmitted by the general node-base stations and information to be transmitted by the super node-base stations themselves according to the interference cancellation coding scheme, and then perform interference alignment on and transmit the same.

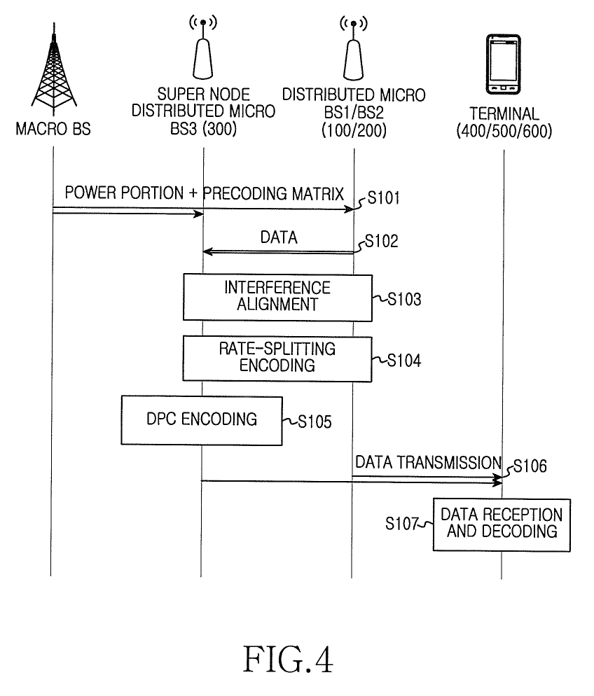

FIG. 4 illustrates a flowchart of a processing data transmitting/receiving operation according to an embodiment of the present disclosure. In step S101, a macro base station transmits information about a power allocation ratio to base stations 100, 200 and 300, and also provides a pre-coding matrix to base stations 100, 200 and 300. If a maximum power which each base station can transmit is limited to P, the sum of the power of respective messages to be transmitted is limited to P. Upon power allocation, the macro base station transmits information about power portions of the messages to be transmitted to base stations. For example, if a power required to transmit a private message is (1-a)P, and a power required to transmit a common message is aP in any base station, the macro base station transmits information “a” about a power allocation ratio to a corresponding base station. The pre-coding matrix means a kind of beam-forming matrix for determining the direction of a beam. An effective channel is generated by multiplying a real channel by the beam forming matrix, and signals are transmitted through the effective channel. When the beam forming matrix for performance of interference alignment is used, signals to be transmitted actually are transmitted through a channel in which an interference is aligned.

In step S202, the general node-base stations 100 and 200 transmit data to the super node-base station 300. An operation for determining a super node among a plurality of distributed small base stations is determined depending on the information delivery ability of a backhaul link as described with reference to FIG. 1. When unidirectional information sharing, is only possible according to backhaul capacity, the base station 300 is determined as a super node. Data transmitted from the general node-base stations is independent of signals to be transmitted by the base stations 100 and 200. For example, the base station 100 transmits an independent signal W1′ of a signal W1 to be transmitted by the base station 100 itself to the base station 300, and the base station 200 transmits an independent signal W2′ of a signal W2 to be transmitted by the base station 200 itself to the base station 300. The transmission of the independent signal from the general nodes to the super node is performed through the backhaul link.

In step S103, the respective base stations 100, 200 and 300 perform interference alignment on signals to be transmitted, and, in step S104, perform rate-splitting encoding on the signals to be transmitted. In step S105, the super node-base station 300 performs DPC encoding operation. In step S106, the respective base stations 100, 200 and 300 perform signal transmission operation. In this case, the general node-base stations 100 and 200 perform rate-splitting encoding and interference alignment on signals to be transmitted by the general-node base stations themselves and transmit the same. On the other hand, the super node-base station 300 performs rate-splitting encoding on signals provided from the general nodes, performs encoding using a DPC scheme on a result of the rate-splitting encoding and a signal to be transmitted by super node-base station 300 itself and then performs interference alignment on and transmits the same. In step S107, the mobile terminals 400, 500 and 600 receive and decode information transmitted from the base stations. The signal transmission operation of the base stations and the signal reception operation of the mobile terminals will be apparent from the following description.

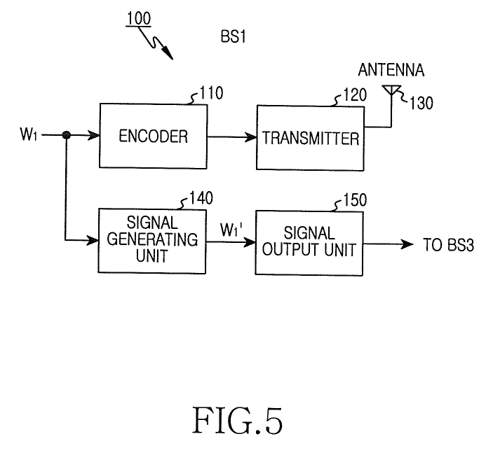

FIG. 5 illustrates a configuration of the general node-base station 100 illustrated in FIG. 4 concretely. The base station 100 includes an encoder 110, a transmitter 120, an antenna 130, a signal generating unit 140, and a signal output unit 150. The encoder 110 performs rate-splitting encoding on a signal W₁ to be transmitted. The transmitter 120 transforms a signal resulting from the encoding by the encoder 110 into a signal suitable for transmission through the antenna 130. The antenna 130 transmits the signal output from the transmitter 120 to the air. The signal generating unit 140 generates an independent signal W_{1′}, of the signal W₁ to be transmitted. The signal output unit 150 outputs the independent signal W_{1′}, to a super node-base station BS3. In an example, the signal output from the signal output unit 150 is provided to the base station BS3 through a backhaul link (not shown).

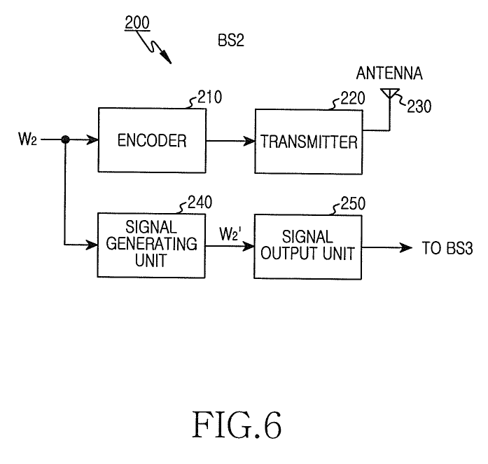

FIG. 6 illustrates a configuration of the general node-base station 200 illustrated in FIG. 4 concretely. The base station 200 includes an encoder 210, a transmitter 220, an antenna 230, a signal generating unit 240, and a signal output unit 250. The encoder 210 performs rate-splitting encoding on a signal W₂ to be transmitted. The transmitter 220 transforms a signal resulting from the encoding by the encoder 210 into a signal suitable for transmission through the antenna 230. The antenna 230 transmits the signal output from the transmitter 220 to the air. The signal generating unit 240 generates an independent signal W_{2′} of the signal W₂ to be transmitted. The signal output unit 250 outputs the independent signal W_{2′} to the super node-base station BS3. In an example, the signal output from the signal output unit 250 is provided to the base station BS3 through a backhaul link (not shown).

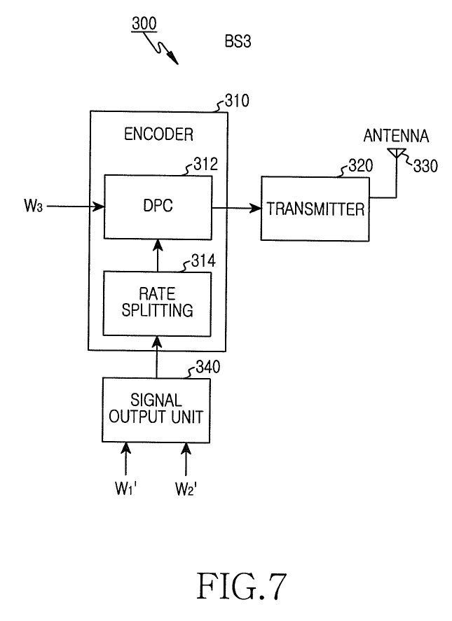

FIG. 7 illustrates a configuration of the super node-base station 300 illustrated in FIG. 4 concretely. The base station 300 includes an encoder 310, a transmitter 320, an antenna 330, and a signal input unit 340. The signal input unit 340 receives signals W_{1′} and W_{2′} respectively output from the general node-base stations 100 and 200. The signal W_{1′} output from the general-node base station 100 is independent of the signal W₁ to be transmitted by the base station 100. The signal W_{2′} output from the general-node base station 200 is independent of the signal W₂ to be transmitted by the base station 200. The signals W_{1′}, and W_{2′} respectively output from the general node-base stations 100 and 200 may be input to the signal input unit 340 through a backhaul link (not shown).

The encoder 310 includes a first encoding block 312 and a second encoding block 314. In an example, the first encoding block 312 may be an encoder using a Dirty Paper Coding (DPC) scheme, which is a representative interference cancellation coding scheme, and the second encoding block 314 may be a rate-splitting encoder. The second encoding block 314 performs rate-splitting encoding on the signals input to the signal input unit 340, that is, the signals W_{1′} and W_{2′} respectively output from the general node-base stations 100 and 200. The first encoding block 312 performs DPC encoding on an encoding result of the second encoding block 314 and a signal W₃ to be transmitted by the base station 300. The transmitter 320 transforms a signal resulting from the encoding by the encoder 310 into a signal suitable for transmission through the antenna 330. The antenna 330 transmits the signal output from the transmitter 320 to the air.

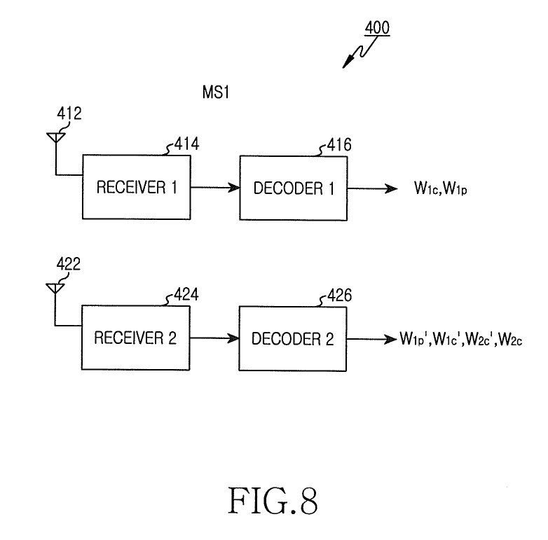

FIG. 8 illustrates a configuration of the mobile terminal 400 corresponding to the general node-base station 100 illustrated in FIG. 4 concretely. The mobile terminal 400 includes a first antenna 412, a first receiver 414 and a first decoder 416, which belong to a first reception dimension, and a second antenna 422, a second receiver 424 and a second decoder 426, which belong to a second reception dimension. The first reception dimension is a signal dimension for receiving signals transmitted from the a corresponding base station 100, and the second reception dimension is an interference dimension for receiving other signals than the signals transmitted from the base station 100, that is, signals transmitted from other base stations 200 and 300.

The first receiver 414 of the first reception dimension receives signals transmitted from a corresponding base station 100 and received through the first antenna 412. The first decoder 416 performs rate-splitting decoding on the signals received at the receiver 414. As a result of the decoding by the first decoder 416, a private message W_{1P} and a common message W_{1C}, which are associated with a signal W₁ transmitted from the base station 100, are output. The first receiver 424 of the second reception dimension receives signals transmitted from other base stations 200 and 300 than the corresponding base station 100 and received through the second antenna 422. The second decoder 426 performs rate-splitting decoding on the signals received at the receiver 424. As a result of the decoding by the second decoder 426, a common message W_{2C} which is associated with a signal W₂ transmitted from the base station 200, a private message W_{1P′} and a common message W_{1C′} which are associated with a signal W_{1′} transmitted from the base station 300, and a common message W_{2C′}, which is associated with a signal W_{2′} transmitted from the base station 300 are output.

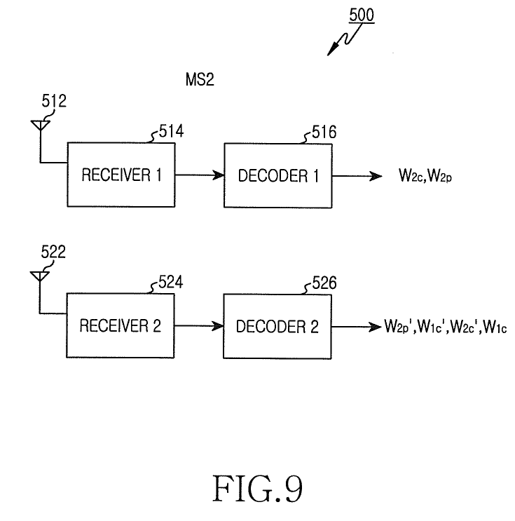

FIG. 9 illustrates a configuration of the mobile terminal 500 corresponding to the general node-base station 200 illustrated in FIG. 4 concretely. The mobile terminal 500 includes a first antenna 512, a first receiver 514 and a first decoder 516, which belong to a first reception dimension, and a second antenna 522, a second receiver 524 and a second decoder 526, which belong to a second reception dimension. The first reception dimension is a signal dimension for receiving signals transmitted from the a corresponding base station 200, and the second reception dimension is an interference dimension for receiving other signals than the signal transmitted from the base station 200, that is, signals transmitted from other base stations 100 and 300.

The first receiver 514 of the first reception dimension receives signals transmitted from the corresponding base station 200 and received through the first antenna 512. The first decoder 516 performs rate-splitting decoding on the signals received at the receiver 514. As a result of the decoding by the first decoder 516, a private message W_{2P} and a common message W_{2C}, which are associated with a signal W₂ transmitted from the base station 200, are output. The second receiver 524 of the second reception dimension receives signals transmitted from other base stations 100 and 300 than the corresponding base station 200 and received through the second antenna 522. The second decoder 526 performs rate-splitting decoding on the signals received at the receiver 524. As a result of the decoding by the second decoder 526, a common message W_{1C} which is associated with a signal W₁ transmitted from the base station 100, a common message W_{1C′} which is associated with a signal W_{1′} transmitted from the base station 300, and a private message W_{2P′} and a common message W_{2C′}, which are associated with a signal W_{2′} transmitted from the base station 300 are output.

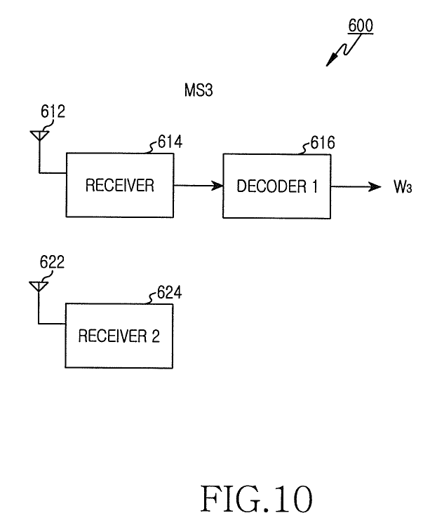

FIG. 10 illustrates a configuration of the mobile terminal 600 corresponding to the super node-base station 300 illustrated in FIG. 4 concretely. The mobile terminal 600 includes a first antenna 612, a first receiver 614 and a first decoder 616, which belong to a first reception dimension, and a second antenna 622, and a second receiver 624, which belong to a second reception dimension. The first reception dimension is a signal dimension for receiving signals transmitted from the a corresponding base station 300, and the second reception dimension is an interference dimension for receiving other signals than the signal transmitted from the base station 300, that is, signals transmitted from other base stations 100 and 200.

The first receiver 614 of the first reception dimension receives signals transmitted from a corresponding base station 300 and received through the first antenna 612. The first decoder 616 performs DPC decoding on the signals received at the receiver 614. As a result of the decoding by the first decoder 616, a signal W₃ is decoded without being affected by an interference due to signals W_{1′} and W_{2′}. The first receiver 624 of the second reception dimension receives signals transmitted from other base stations 100 and 200 than the corresponding base station 300 and received through the second antenna 622.

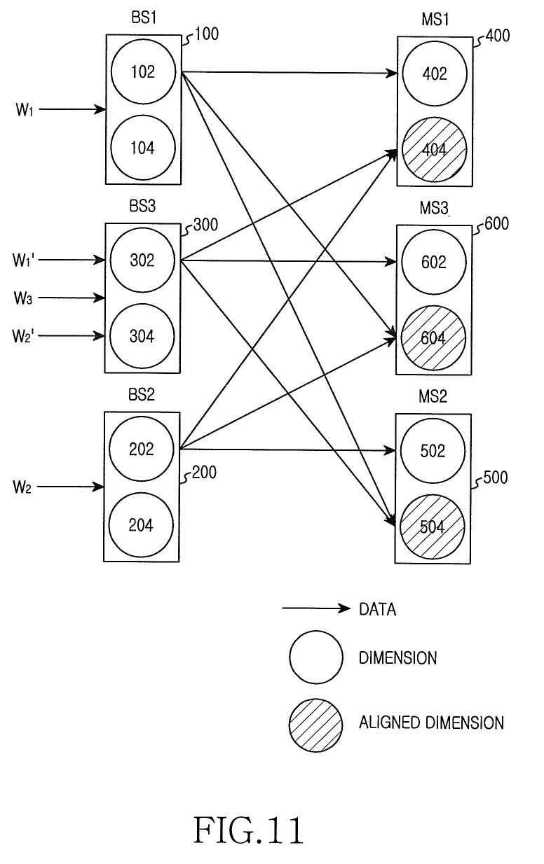

FIG. 11 illustrates an operation for transmitting/receiving data according to an embodiment of the present disclosure. A general node-base station 100 includes a first transmission dimension 102 which is a signal dimension, and a second transmission dimension 104 which is an interference dimension, a general node-base station 200 includes a first transmission dimension 202 which is a signal dimension, and a second transmission dimension 204 which is an interference dimension, and the super node-base station 300 includes a first transmission dimension 302 which is a signal dimension, and a second transmission dimension 304 which is an interference dimension. A mobile terminal 400 corresponding to the general node-base station 100 includes a first reception dimension 402 which is a signal dimension, and a second reception dimension 404 which is an interference dimension, the mobile terminal 500 corresponding to the general node-base station 200 includes a first reception dimension 502 which is a signal dimension, and a second reception dimension 504 which is an interference dimension, and the mobile terminal 600 corresponding to the super node-base station 300 includes a first reception dimension 602 which is a signal dimension, and a second reception dimension 604 which is an interference dimension.

The base station 100 transmits a signal W₁ to be transmitted through the signal dimension 102. The signal transmitted as described above is received in the signal dimension 402 of the mobile terminal 400, in the interference dimension 504 of the mobile terminal 500, and in the interference dimension 604 of the mobile terminal 600. The base station 200 transmits a signal W₂ to be transmitted through the signal dimension 202. The signal transmitted as described above is received in the signal dimension 502 of the mobile terminal 500, in the interference dimension 404 of the mobile terminal 400, and in the interference dimension 604 of the mobile terminal 600. The base station 300 transmits signals W₃, W_{1′} and W_{2′} to be transmitted through the signal dimension 302. The signals transmitted as described above is received in the signal dimension 602 of the mobile terminal 600, in the interference dimension 404 of the mobile terminal 400, and in the interference dimension 504 of the mobile terminal 500.

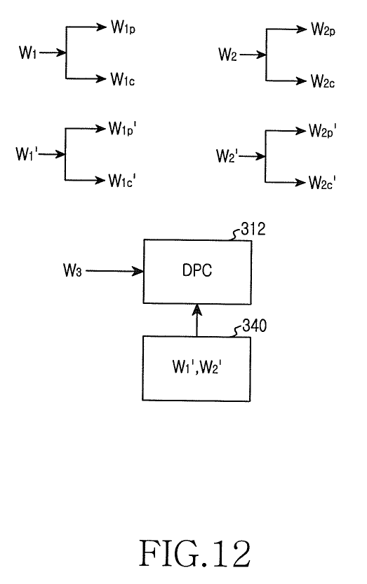

FIG. 12 illustrates an operation for transmitting data in the base stations illustrated in FIG. 11. General node-base stations 100 and 200 perform rate splitting encoding on signals to be transmitted. The base station 100 performs rate-splitting on a signal W₁ to be transmitted, and transmits a private message W_{1P} and a common message W_{1c}. The base station 200 performs rate-splitting on a signal W₂ to be transmitted, and transmits a private message W_{2P} and a common message W_{2C}.

A super node-base station 300 performs rate splitting encoding and DPC encoding on a signal to be transmitted. The signal input unit 340 illustrated in FIG. 7 receives a signal W_{1′} from the base station 100 and a signal W_{2′} from the base station 200. The rate-splitting, encoding block 314 performs rate-splitting encoding on the received signal W_{1′} and outputs a private message signal W_{1P′} and a common message signal W_{1C′}. Also, the rate-splitting encoding, block 314 performs rate-splitting encoding on the received signal W_{2′} and outputs a private message signal W_{2P′} and a common message signal W_{2C′}. The DPC encoding block 312 performs DPC encoding on results of encoding for the signals W_{1′} and W_{2′} and the signal W₃ for transmission.

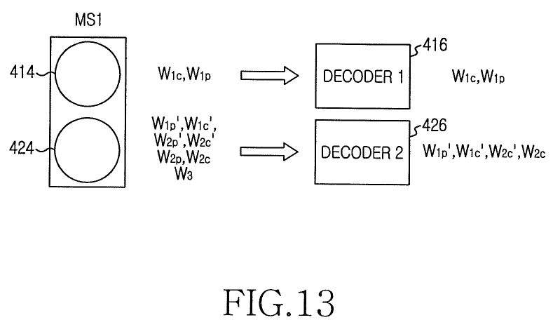

FIG. 13 illustrates operations for receiving data in the mobile terminal MS1 400 illustrated in FIG. 11. The first receiver 414 of a first reception dimension 402 receives a signal transmitted from a corresponding, base station 100. A first decoder 416 performs rate-splitting decoding on the signal received at the receiver 414. As a result of decoding by the first decoder 416, a private message W₁ₚ and a common message W_{1C}, which are associated with a signal W1 transmitted from the base station 100, are output. The second receiver 424 of a second reception dimension 404 receives signals transmitted from other base stations 200 and 300 than the corresponding base station 100. A second decoder 426 performs rate-splitting decoding on the signals received at the receiver 424. As a result of decoding by the second decoder 426, a common message W_{2C} which is associated with a signal W₂ transmitted from the base station 200, a private message W_{1P′} and a common message W_{1C′} which are associated with the signal W_{1′} transmitted from the base station 300, and a common message W_{2C′}, which is associated with a signal W_{2′} transmitted from the base station 300 are output.

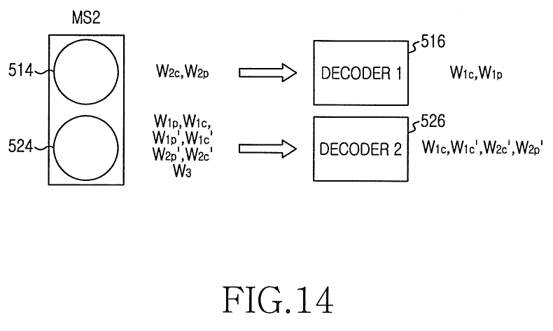

FIG. 14 illustrates an operation for receiving data in the mobile terminal MS2 500 illustrated in FIG. 11. The first receiver 514 of a first reception dimension 502 receives a signal transmitted from a corresponding base station 200. A first decoder 516 performs rate-splitting decoding on the signal received at the receiver 514. As a result of decoding by the first decoder 516, a private message W_{2P} and a common message W_{2C}, which are associated with a signal W₂ transmitted from the base station 200, are output. The second receiver 524 of a second reception dimension 504 receives signals transmitted from other base stations 100 and 300 than the corresponding base station 200. A second decoder 526 performs rate-splitting decoding on the signals received at the receiver 524. As a result of decoding by the second decoder 526, a common message W_{1C} which is associated with a signal W₁ transmitted from the base station 100, a common message W_{1C′} which is associated with a signal W_{1′} transmitted from the base station 300, and a private message W_{2P′} and a common message W_{2C′}, which are associated with a signal W_{2′} transmitted from the base station 300 are output.

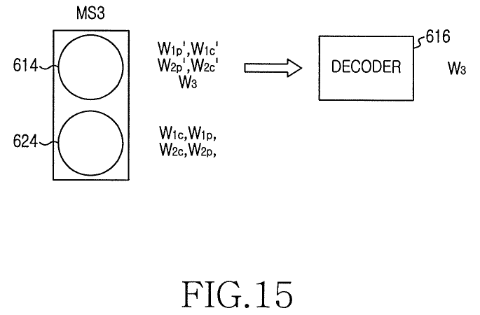

FIG. 15 illustrates an operation for receiving data in the mobile terminal MS3 600 illustrated in FIG. 11. The first receiver 614 of a first reception dimension 602 receives a signal transmitted from a corresponding base station 300. A first decoder 616 performs DPC decoding on the signal received at the receiver 614. As a result of decoding by the first decoder 616, a signal W₃ is decoded without being affected by an interference due to signals W_{1′} and W_{2′}. The second receiver 624 of a second reception dimension 604 receives signals transmitted from other base stations 100 and 200 than the corresponding base station 300.

As described above, according to an embodiment of the present disclosure, any one base station of base stations is determined as a super node and the rest base stations are respectively determined as a general node in a mobile communication system, such as, a VCN in which distributed small base stations partially cooperate with each other. The general node-base stations perform interference alignment on only signals to be transmitted by the general node-base stations themselves, and transmit the same. On the other hand, the super node-base station performs interference alignment on signals received from the general node-base stations and a signal to be transmitted by the super node-base station itself, and transmits the same. As a result, mobile terminals corresponding to the general node-base stations performs decoding even in an interference dimension, which has not been decoded in an existing interference alignment method. Therefore, the mobile terminals corresponding to the general node-base stations can acquire an additional dimension according to the intensity of an interference channel, thereby acquiring advantages not only in terms of Degrees of Freedom (DoF) but also in terms of performance.

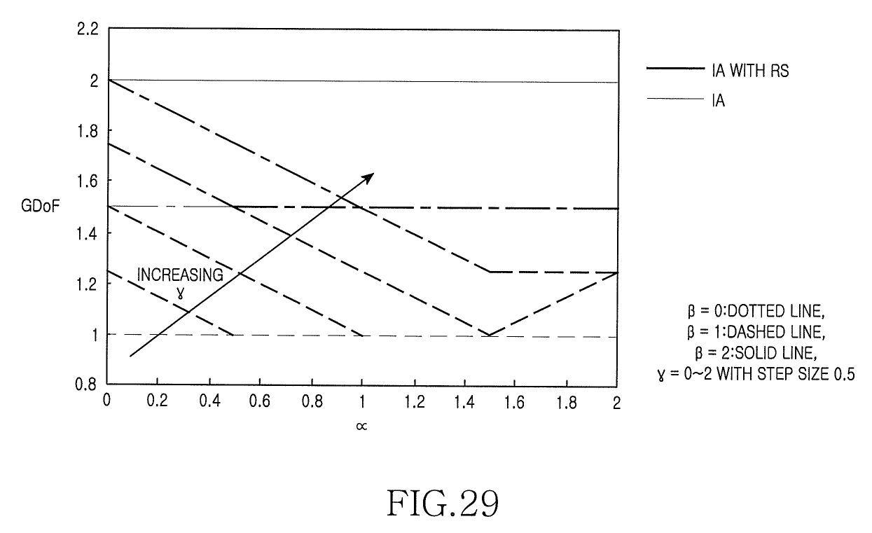

For example, when a channel gain between a base station and mobile terminals in the case of the interference alignment scheme as illustrated in FIG. 2 is compared to a channel gain between a base station and mobile terminals in the case of the interference alignment scheme according to an embodiment of the present disclosure, the following Table 1 is obtained, and a graph representing performance test results related with the Table 1 is illustrated in FIG. 29.

TABLE 1

| Prior art | Embodiment of the present disclosure |
|---|---|
| Channel gain (BS3 → | Channel gain (BS3 → MS1/MS2) > |
| MS1/MS2) ≦ | |
| Channel gain (BS3 → MS3) | Channel gain (BS3 → MS3) |

FIG. 29 illustrates the performance of data transmission/reception operation according to an embodiment of the present disclosure and showing the relationship of α vs. GDoF (Generalized Degrees of Freedom). In this case, DoF represents a multiplexing gain which may be acquired through a specific method. In order words, DoF means an available dimension. GDoF is a measured value acquired by reflecting channel characteristics to DoF a little more. Generally, a DoF value is not affected by channel size.

In FIG. 29, dark lines correspond to embodiments of the present disclosure, and gray lines correspond to an existing method. Dotted lines represent the case of β=0, dashed lines represent the case of β=1, and solid lines represent the case of β=2. γ is a value between 0 and 2, which increases at intervals of 0.5. α, β and γ are defined as in following Equation (1) to Equation (3) respectively, and, in Equation (1) to Equation (3), INR, SNR, SNR₃ and INR₃ are defined as in following Equation (4) to Equation (7) respectively.

$$\begin{matrix}α = \frac{log INR}{log S N R} & ( 1 ) \\ β = \frac{log {SNR}_{3}}{log S N R} & ( 2 ) \\ γ = \frac{log {INR}_{3}}{log S N R} & ( 3 ) \\ S N R = \frac{{\vert {h}_{11} \vert}^{2}}{{N}_{O}} = \frac{{\vert {h}_{22} \vert}^{2}}{{N}_{O}} & ( 4 ) \\ INR = \frac{{\vert {h}_{12} \vert}^{2}}{{N}_{O}} = \frac{{\vert {h}_{21} \vert}^{2}}{{N}_{O}} & ( 5 ) \\ {SNR}_{3} = \frac{{\vert {h}_{33} \vert}^{2}}{{N}_{O}} & ( 6 ) \\ {INR}_{3} = \frac{{\vert {h}_{13} \vert}^{2}}{{N}_{O}} = \frac{{\vert {h}_{23} \vert}^{2}}{{N}_{O}} & ( 7 )\end{matrix}$$

In Equation (4) to Equation (7), hij represents a channel gain between a transmitter Tx j and a receiver Rx i. Therefore, h₁₁ represents a channel gain between the base station BS1 100 and the mobile terminal MS1 100, h₂₂ represents a channel gain between the base station BS2 200 and the mobile terminal MS2 200, h₁₂ represents a channel gain between the base station BS2 200 and the mobile terminal MS1 100, and h₂₁ represents a channel gain between the base station BS1 100 and the mobile terminal MS2 200.

As known from Table 1, according to an existing interference alignment scheme, the channel gain between the base station BS3 and the mobile terminal MS1/MS2 is smaller than or identical to the channel gain between the base station BS3 and its corresponding mobile terminal MS3. On the other hand, according to an interference alignment scheme according to an embodiment of the present disclosure, the channel gain between the super node-base station BS3 and the mobile terminal MS1/MS2 which does not correspond thereto is larger than the channel gain between the base station BS3 and its corresponding mobile terminal MS3. As known from FIG. 29, the interference alignment scheme according to the embodiment of the present disclosure has larger degrees of freedom than existing interference alignment scheme.

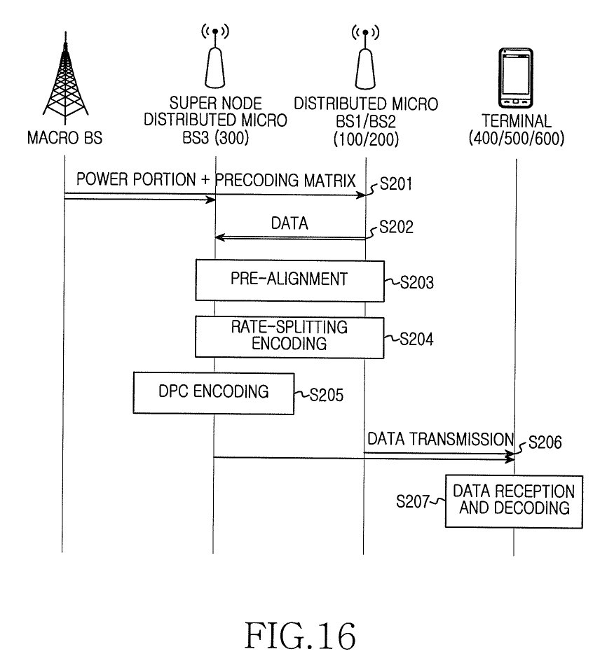

FIG. 16 illustrates a flowchart of a processing operation for transmitting and receiving data according to another embodiment of the present disclosure. In step S201, a macro base station transmits information about a power allocation ratio to base stations 100, 200 and 300, and also provides a pre-coding matrix to base stations 100, 200 and 300. If a maximum power which each base station can transmit is limited to P, the sum of the powers of respective messages to be transmitted is limited to P. Upon power allocation, the macro base station transmits information about power portions of the messages to be transmitted to base stations. For example, if a power required to transmit a private message is (1-a)P, and a power required to transmit a common message is aP in any base station, the macro base station transmits information “a” about the power allocation ratio to a corresponding base station. The pre-coding matrix means a kind of beam-forming matrix for determining the direction of a beam. An effective channel is generated by multiplying a real channel by the beam forming matrix, and signals are transmitted through the effective channel. When the beam forming matrix for performance of interference alignment is used, signals to be transmitted actually are transmitted through a channel in which an interference is aligned.

In step S202, the general node-base stations 100 and 200 transmit data to the super node-base station 300. An operation for determining a super node among a plurality of distributed small base stations is determined depending on the information delivery ability of a backhaul link as described with reference to FIG. 1. When unidirectional information sharing is only possible according to backhaul capacity, the base station 300 is determined as a super node. Data transmitted from the general node-base stations includes signals to be transmitted by base stations 100 and 200 and signals independent of the signals to be transmitted by the base stations 100 and 200. For example, the base station 100 transmits a signal W₁ to be transmitted by the base station 100 itself and an independent signal W_{1′} of the signal W₁ to the base station 300, and the base station 200 transmits a signal W₂ to be transmitted by the base station 200 itself and an independent signal W_{2′} of the signal W₂ to the base station 300. The transmission of the independent signal from the general nodes to the super node is performed through a backhaul link.

In step S203, the respective base stations 100, 200 and 300 perform pre-alignment on signals to be transmitted and, in step S204, perform rate-splitting encoding on the signals to be transmitted. In step S205, the super node-base station 300 performs DPC encoding operation. In step S206, the respective base stations 100, 200 and 300 performs a signal transmission operation. In this case, the general node-base stations 100 and 200 perform rate splitting encoding and interference alignment on signals to be transmitted by general node-base stations 100 and 200 themselves and transmit the same. On the other hand, the super node-base station 300 receives signals to be transmitted by the general nodes along with independent signals of the signal to be transmitted, from the general nodes, performs rate-splitting encoding on the signals to be transmitted by the general nodes and the independent signals of the signal to be transmitted, performs encoding operation based on a DPC scheme, and then interference alignment on results of the encoding and a signal to be transmitted by the super node-base station itself, and transmits the same. In step S207, the mobile terminals 400, 500 and 600 receive and decode information transmitted from the base stations. The signal transmission operation of the base stations and the signal reception operation of the mobile terminals are more clearly apparent from the following description.

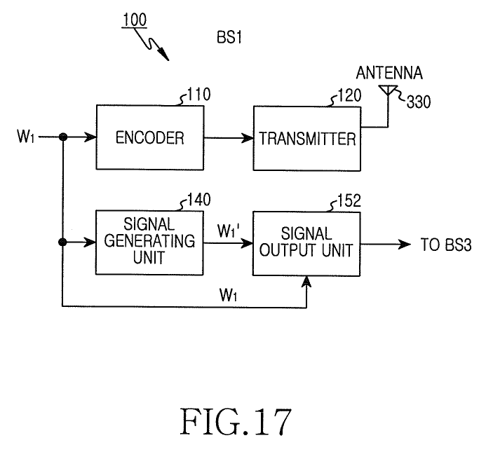

FIG. 17 illustrates a configuration of the general node-base station 100 illustrated in FIG. 16 concretely. The base station 100 includes an encoder 110, a transmitter 120, an antenna 130, a signal generating unit 140, and a signal output unit 152. The encoder 110 performs rate-splitting encoding on a signal W₁ to be transmitted. The transmitter 120 transforms a signal resulting from encoding by the encoder 110 into a signal suitable for transmission through the antenna 130. The antenna 130 transmits the signal output from the transmitter 120 to the air. The signal generating unit 140 generates an independent signal W_{1′} of the signal W₁ to be transmitted. The signal output unit 152 outputs the signal W₁ to be transmitted along with the independent signal W_{1′} to the super node-base station BS 3. In an example, the signals output from the signal output unit 152 are provided to the base station BS3 through a backhaul link (not shown).

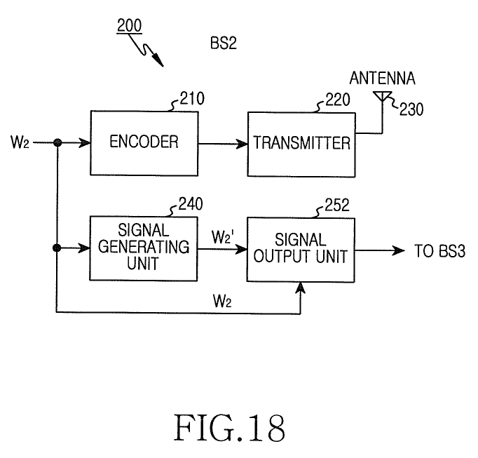

FIG. 18 illustrates a configuration of the general node-base station 200 illustrated in FIG. 16 concretely. The base station 200 includes an encoder 210, a transmitter 220, an antenna 230, a signal generating unit 240, and a signal output unit 252. The encoder 210 performs rate-splitting encoding on a signal W₂ to be transmitted. The transmitter 220 transforms a signal resulting from encoding by the encoder 210 into a signal suitable for transmission through the antenna 230. The antenna 230 transmits the signal output from the transmitter 220 to the air. The signal generating unit 240 generates an independent signal W_{2′} of the signal W₂ to be transmitted. The signal output unit 252 outputs the signal W₂ to be transmitted along with the independent signal W_{2′} to the super node-base station BS3. In an example, the signals output from the signal output unit 252 are provided to the base station BS3 through a backhaul link (not shown).

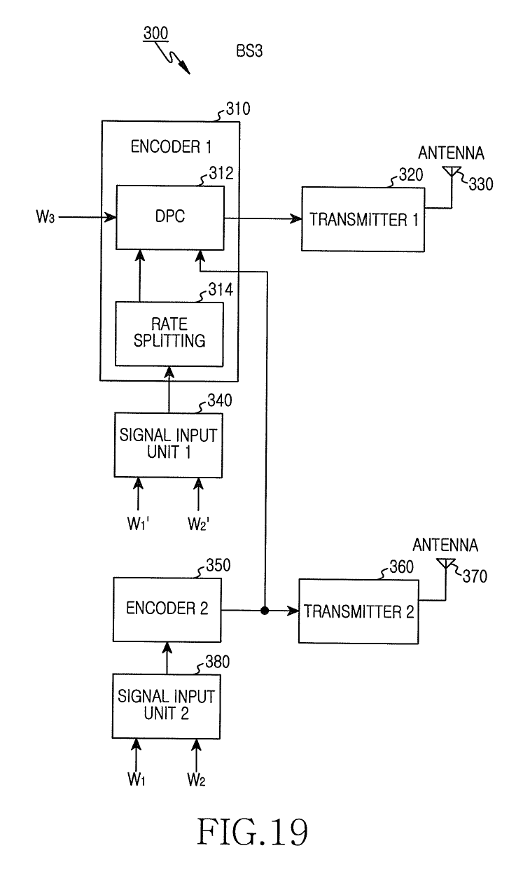

FIG. 19 illustrates a configuration of the super node-base station 300 illustrated in FIG. 16 concretely. The base station 300 includes a first encoder 310, a first transmitter 320, a first antenna 330, and a first signal input unit 340 which belong to a first transmission dimension. The base station 300 includes a second encoder 350, a second transmitter 360, a second antenna 370, and a second signal input unit 380 which belong to a second transmission dimension.

The second signal input unit 380 receives signals W₁ and W₂ respectively output from general node-base stations 100 and 200. The signal W₁ output from the general-node base station 100 is a signal to be transmitted by the base station 100. The signal W₂ output from the general-node base station 200 is a signal to be transmitted by the base station 200. The signals W₁ and W₂ respectively output from the general node-base stations 100 and 200 may be input to the second signal input unit 380 through a backhaul link (not shown). The second encoder 350 performs rate-splitting encoding on the signals W₁ and W₂ received through the second signal input unit 380. The signal resulting from encoding by the second encoder 350 is output to the first encoding block 312 of the first encoder 310 and the second transmitter 360. The second transmitter 360 transforms a signal resulting from encoding by the second encoder 350 into a signal suitable for transmission through the antenna 370. The antenna 370 transmits the signal output from the second transmitter 360 to the air.

The first signal input unit 340 receives signals W_{1′} and W_{2′} respectively output from the general node-base stations 100 and 200. The signal W_{1′} output from the general-node base station 100 is independent of the signal W₁ to be transmitted by the base station 100. The signal W_{2′} output from the general-node base station 200 is independent of the signal W₂ to be transmitted by the base station 200. The signals W_{1′} and W_{2′} respectively output from the general node-base stations 100 and 200 may be input to the signal input unit 340 through a backhaul link (not shown).

The first encoder 310 includes a first encoding block 312 and a second encoding block 314. In an example, the first encoding block 312 may be an encoder based on a Dirty Paper Coding (DPC) scheme, which is a representative interference cancellation coding scheme, and the second encoding block 314 may be a rate-splitting encoder. The second encoding block 314 performs rate-splitting encoding on signals input to the signal input unit 340, that is, signals W_{1′} and W_{2′} respectively output from the general node-base stations 100 and 200. The first encoding block 312 performs DPC encoding on a result of encoding by the second encoder 350, a result of encoding by the second encoding block 314, and a signal W₃ to be transmitted by the base station 300. The first transmitter 320 transforms a signal resulting from encoding by the first encoder 310 into a signal suitable for transmission through the antenna 330. The antenna 330 transmits the signal output from the first transmitter 320 to the air.

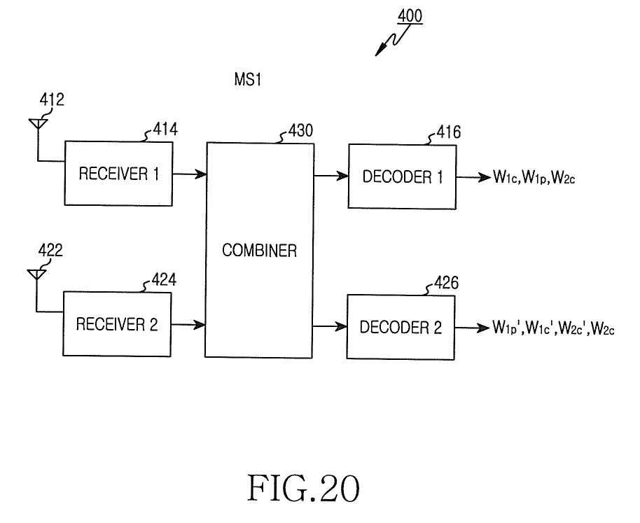

FIG. 20 illustrates a configuration of the mobile terminal 400 corresponding to the general node-base station 100 illustrated in FIG. 16 concretely. The mobile terminal 400 includes a first antenna 412, a first receiver 414 and a first decoder 416, which belong to a first reception dimension, and a second antenna 422, a second receiver 424 and a second decoder 426, which belong to a second reception dimension. In addition, the mobile terminal 400 includes a combiner 430. The first reception dimension is a signal dimension for receiving, a signal transmitted from a corresponding base station 100 and a signal transmitted from the second transmission dimension of the super node-base station 300. The second reception dimension is an interference dimension for receiving a signal transmitted from the first transmission dimension of the super node-base station 300 and a signal transmitted from another general node-base station 200.

The first receiver 414 of the first reception dimension receives a signal transmitted from the corresponding base station 100 and received through the first antenna 412, and a signal transmitted from the second transmission dimension of the super node-base station 300. The combiner 430 performs combining on the output of the first receiver 414. The first decoder 416 performs rate-splitting decoding on a signal resulting from combining by the combiner 430. As a result of decoding by the first decoder 416, a private message W_{1P} and a common message W_{1C}, which are associated with the signal W₁ transmitted from the base station 100, and a common message W_{2C} which is associated with the signal W₂ transmitted from the base station 300 are output.

The second receiver 424 of the second reception dimension receives a signal transmitted from the first transmission dimension of the super node-base station 300 and received through the second antenna 422, and a signal transmitted from another general node-base station 200. The combiner 430 performs combining on the output of the second receiver 424. The second decoder 426 performs rate-splitting decoding on a signal resulting from combining by the combiner 430. As a result of decoding by the second decoder 426, a common message W_{2C} which is associated with the signal W₂ transmitted from the base station 200, a private message W_{1P′} and a common message W_{1C′} which are associated with the signal W_{1′} transmitted from the base station 300, and a common message W_{2C′}, which is associated with the signal W_{2′} transmitted from the base station 300 are output.

The combiner 430 performs phase synchronization for signals based on the common message W_{2C} associated with the signal W₂ among signals received commonly by the first receiver 414 and the second receiver 424 and performs combining by adding the signals. Based on a result of combining by the combiner 430, the first decoder 416 and the second decoder 426 decode the common message W_{2C}. For example, the combiner 430 may be a combiner using maximal ratio combining.

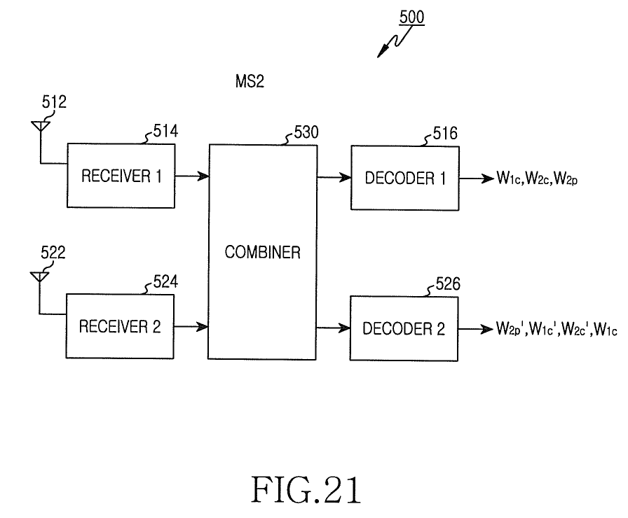

FIG. 21 illustrates a configuration of the mobile terminal 500 corresponding to the general node-base station 200 illustrated in FIG. 16 concretely. The mobile terminal 500 includes a first antenna 512, a first receiver 514 and a first decoder 516, which belong to a first reception dimension, and a second antenna 522, a second receiver 524 and a second decoder 526, which belong to a second reception dimension. In addition, the mobile terminal 500 includes a combiner 530. The first reception dimension is a signal dimension for receiving a signal transmitted from a corresponding base station 200, and a signal transmitted from the second transmission dimension of a super node-base station 300. The second reception dimension is an interference dimension for receiving a signal transmitted from the first transmission dimension of the super node-base station 300, and a signal transmitted from another general node-base station 100.

The first receiver 514 of the first reception dimension receives a signal transmitted from the corresponding base station 200 and received through the first antenna 512, and a signal transmitted from the second transmission dimension of the super node-base station 300. The combiner 530 performs combining on the output of the first receiver 514. The first decoder 516 performs rate-splitting decoding on a signal resulting from combining by the combiner 530. As a result of decoding by the first decoder 516, a private message W_{2P} and a common message W_{2C}, which are associated with the signal W₂ transmitted from the base station 200, and a common message W_{1C} which is associated with the signal W₁ transmitted from the base station 300 are output.

The second receiver 524 of the second reception dimension receives a signal transmitted from the first transmission dimension of the super node-base station 300 and received through the second antenna 522, and a signal transmitted from another general node-base station 100. The combiner 530 performs combining on the output of the second receiver 524. The second decoder 526 performs rate-splitting decoding on a signal resulting from combining by the combiner 530. As a result of decoding by the second decoder 526, a common message W_{1C} which is associated with the signal W₁ transmitted from the base station 200, a common message W_{1C′} which is associated with the signal W_{1′} transmitted from the base station 300, and a private message W_{2P′} and a common message W_{2C′}, which are associated with the signal W_{2′} transmitted from the base station 300 are output.

The combiner 530 performs phase synchronization for signals based on the common message W_{1C} associated with the signal W₁ among signals received commonly by the first receiver 514 and the second receiver 524 and performs combining by adding the signals. Based on a result of combining of the combiner 530, the first decoder 516 and the second decoder 526 decode the common message W_{1C}. For example, the combiner 430 may be a combiner using maximal ratio combining.

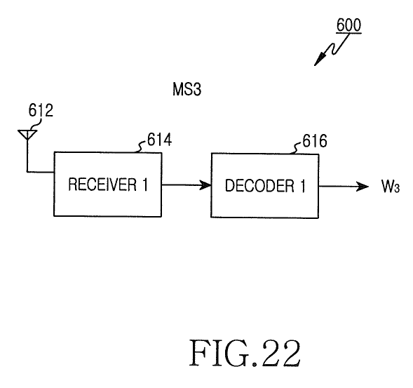

FIG. 22 illustrates a configuration of the mobile terminal 600 corresponding to the super node-base station 300 illustrated in FIG. 16 concretely. The mobile terminal 600 includes an antenna 612, a receiver 614 and a decoder 616 which belong to a reception dimension.

The receiver 614 receives signals transmitted from the first reception dimension and second reception dimension of a corresponding base station 300, and received through the antenna 612 and signals transmitted from general node-base stations 100 and 200. The decoder 616 performs DPC decoding on the signals received at the receiver 614. As a result of decoding by the decoder 616, a signal W₃ is decoded without being affected by an interference due to signals W₁ and W₂ and also without being affected by an interference due to signals W_{1′} and W_{2′}.

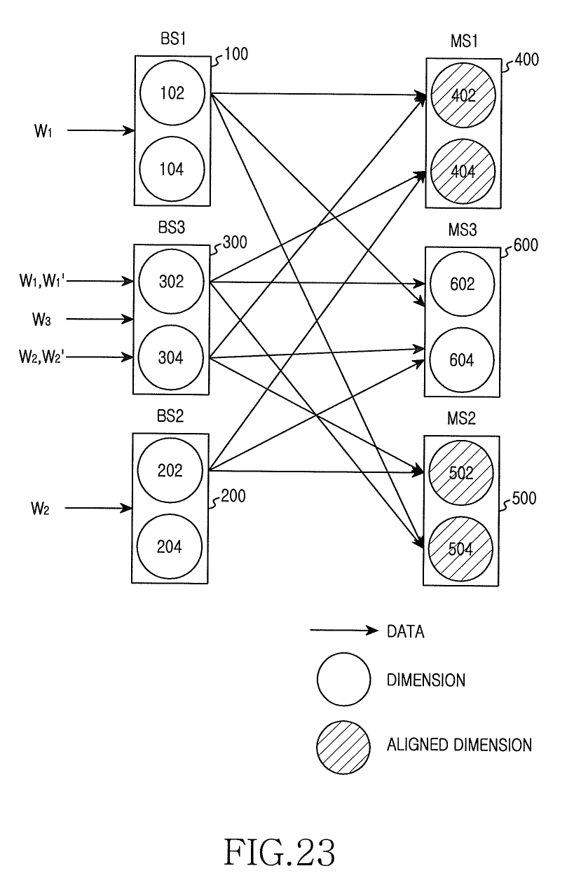

FIG. 23 illustrates an operation for transmitting and receiving data according to another embodiment of the present disclosure. The general node-base station 100 includes a transmission dimension 102 which is a signal dimension, and a second transmission dimension 104 which is an interference dimension, the general node-base station 200 includes a transmission dimension 202 which is a signal dimension, and a second transmission dimension 204 which is an interference dimension, and the super node-base station 300 includes a transmission dimension 302 which is a signal dimension, and a second transmission dimension 304 which is an interference dimension. The mobile terminal 400 corresponding to the general node-base station 100 includes a reception dimension 402 which is a signal dimension, and a second reception dimension 404 which is an interference dimension, the mobile terminal 500 corresponding to the general node-base station 200 includes a reception dimension 502 which is a signal dimension, and a second reception dimension 504 which is an interference dimension, and the mobile terminal 600 corresponding to the super node-base station 300 includes a reception dimension 602 which is a signal dimension, and a second reception dimension 604 which is an interference dimension.

The base station 100 transmits the signal W₁ to be transmitted through the signal dimension 102. The signal transmitted as described above is received in the signal dimension 402 of the mobile terminal 400, in the interference dimension 504 of the mobile terminal 500, and in the signal dimension 602 and the interference dimension 604 of the mobile terminal 600. The base station 200 transmits the signal W₂ to be transmitted through the signal dimension 202. The signal transmitted as described above is received in the signal dimension 502 of the mobile terminal 500, in the interference dimension 404 of the mobile terminal 404, and in the signal dimension 602 and the interference dimension 604 of the mobile terminal 600. The base station 300 transmits a signal W₃ to be transmitted, the signals W_{1′} and W_{2′}, and the signals W₁ and W₂ through the signal dimension 302. In addition, the base station 300 transmits the signals W₁ and W₂ through the interference dimension 304.

The signal transmitted through the signal dimension 302 of the base station 300 is received in the signal dimension 602 of the corresponding mobile terminal 600, in the interference dimension 404 of the mobile terminal 400, and in the interference dimension 504 of the mobile terminal 500. The signal transmitted through the interference dimension 304 of the base station 300 is received in the signal dimension 602 and interference dimension 604 of the corresponding, mobile terminal 600, in the signal dimension 402 of the mobile terminal 400, and at the signal dimension 502 of the mobile terminal 500.

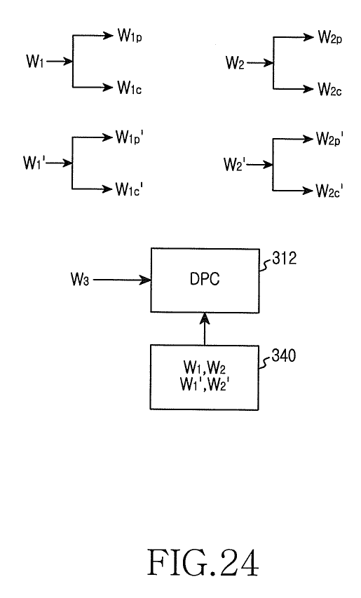

FIG. 24 illustrates an operation for receiving data in the base stations illustrated in FIG. 23. General node-base stations 100 and 200 perform rate splitting encoding on signals to be transmitted. The base station 100 performs rate-splitting on the signal W₁ to be transmitted, and transmits a private message W_{1P} and a common message W_{1C}. The base station 200 performs rate-splitting on the signal W₂ to be transmitted, and transmits a private message W_{2P} and a common message W_{2C}.

A super node-base station 300 performs rate splitting encoding and DPC encoding on a signal to be transmitted. The signal input unit 340 illustrated in FIG. 19 receives a signal W_{1′} from the base station 100 and a signal W_{2′} from the base station 200, and the signal input unit 380 receives a signal W₁ from the base station 100 and a signal W₂ from the base station 200. The encoder 350 performs rate-splitting encoding on the received signal W₁ and outputs a private message signal W_{1P} and a common message signal W_{1C}. Also, the encoder 350 performs rate-splitting encoding on the received signal W₂ and outputs a private message signal W_{2P} and a common message signal W_{2C}. The rate-splitting encoding block 314 performs rate-splitting encoding on the received signal W_{1′} and outputs a private message signal W_{1P′} and a common message signal W_{1C′}. Also, the rate-splitting encoding block 314 performs rate-splitting encoding on the received signal W_{2′} and outputs a private message signal W_{2P′} and a common message signal W_{2C′}. The DPC encoding block 312 performs DPC encoding on results of the encoding of the signals W_{1′} and W_{2′} and the signal W₃ for transmission.

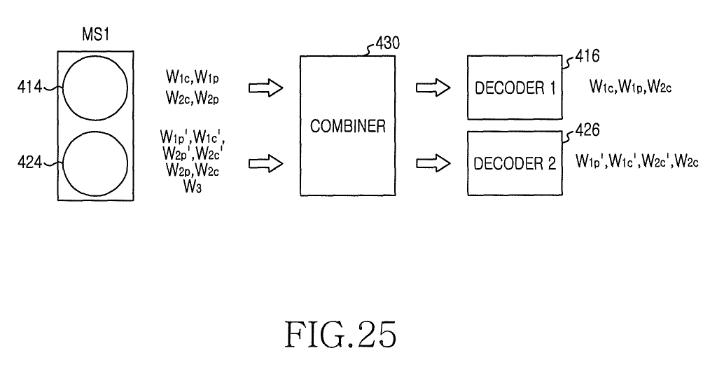

FIG. 25 illustrates an operation for receiving data in the mobile terminal MS1 illustrated in FIG. 23. The first receiver 414 of a first reception dimension 402 receives a signal transmitted from a corresponding base station 100 and a signal transmitted from the second transmission dimension 304 of a base station 300. The second receiver 424 of a second reception dimension 404 receives a signal transmitted from the first transmission dimension 202 of the base station 200 and a signal transmitted from the first transmission dimension 302 of the base station 300. The combiner 430 combines the signal received at the first receiver 414 and the signal received at the second receiver 424. The first decoder 416 performs rate-splitting decoding on a signal resulting from combining by the combiner 430. As a result of decoding by the first decoder 416, a private message W_{1P} and a common message W_{1C}, which are associated with the signal W₁ transmitted from the base station 100, and a common message W_{2C} which is associated with the signal W₂ transmitted from the base station 300 are output. As a result of decoding by the second decoder 426, a common message W_{2C} which is associated with the signal W₂ transmitted from the base station 200, a private message W_{1P′} and a common message W_{1C′} which are associated with the signal W_{1′} transmitted from the base station 300, and a common message W_{2C′} which is associated with the signal W_{2′} transmitted from the base station 300 are output.

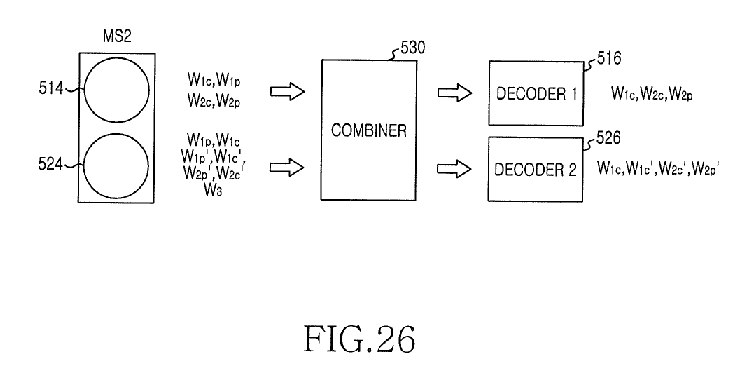

FIG. 26 illustrates an operation for receiving data in the mobile terminal MS2 illustrated in FIG. 23. The first receiver 514 of a first reception dimension 502 receives a signal transmitted from a corresponding base station 200 and a signal transmitted from the second transmission dimension 304 of a base station 300. The second receiver 524 of the second reception dimension 504 receives a signal transmitted from the first transmission dimension 102 of a base station 100 and signals transmitted from the first transmission dimension 302 of the base station 300. The combiner 530 combines the signal received at the first receiver 514 and the signal received at the second receiver 524. The first decoder 516 performs rate-splitting decoding on a signal resulting from combining by the combiner 530. As a result of decoding by the first decoder 516, a private message W_{2P} and a common message W_{2C}, which are associated with the signal W2 transmitted from the base station 200, and a common message W1C which is associated with the signal W₁ transmitted from the base station 300 are output. As a result of the decoding by the second decoder 526, a common message W_{1c} which is associated with the signal W₁ transmitted from the base station 200, a common message W_{1C′} which is associated with the signal W_{1′} transmitted from the base station 300, and a private message W_{2P′} and a common message W_{2C′} which are associated with the signal W_{2′} transmitted from the base station 300 are output.

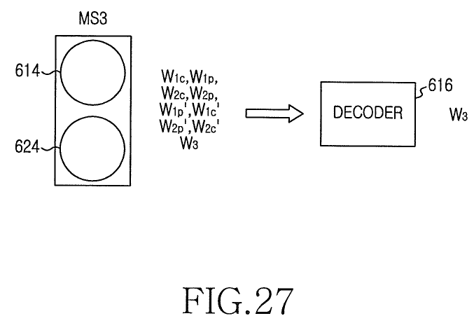

FIG. 27 illustrates an operation for receiving data in the mobile terminal MS3 illustrated in FIG. 23. The receiver 614 receives signals transmitted from the first transmission dimension 302 and second transmission dimension 304 of a corresponding base station 300 and received through the antenna 612 and signals transmitted from general node-base stations 100 and 200. The decoder 616 performs DPC decoding on the signals received at the receiver 614. As a result of decoding by the decoder 616, a signal W₃ is decoded without being affected by an interference due to signals W₁ and W₂ and also without being affected by an interference due to signals W_{1′} and W_{2′}.

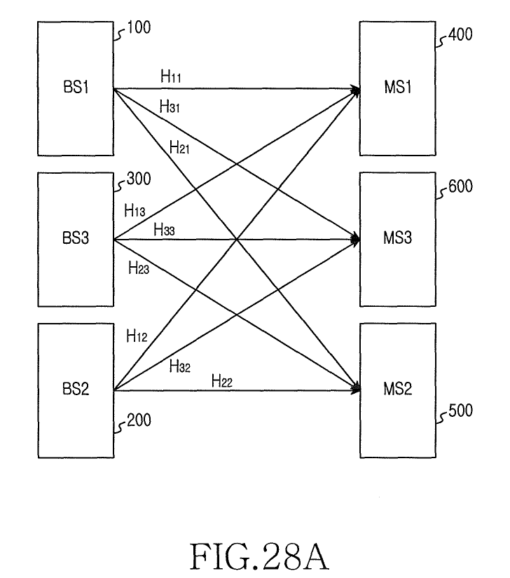

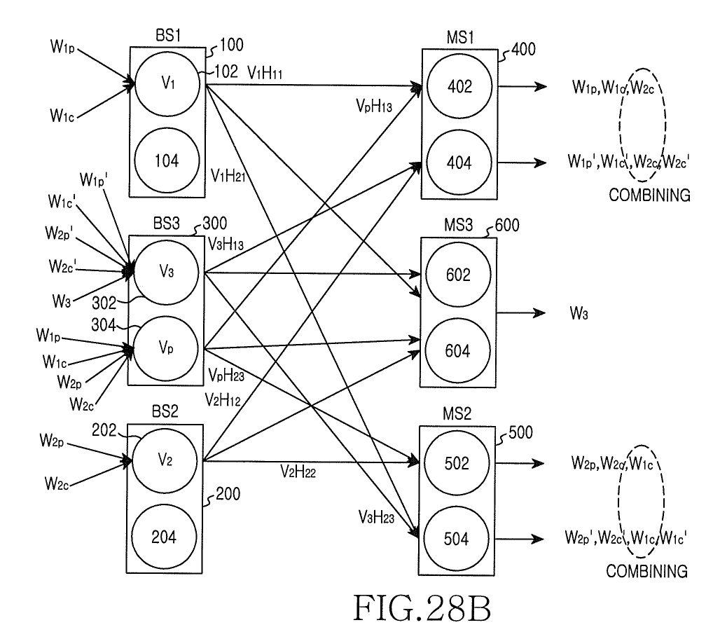

FIGS. 28A and 28B illustrate operations for designing an encoder for data transmission and reception operations according to another embodiment of the present disclosure. According to another embodiment of the present disclosure, pre-alignment is performed on signals to be transmitted. The operations for designing an encoder for pre-alignment are described below.

In FIG. 28a, Hij represents a channel gain in the case of transmitting signals from a base station j to a mobile terminal i. For example, H₁₁ represents a channel gain in the case of transmitting signals from a base station MS1 100 to a mobile terminal 1 400. H₂₁ represents a channel gain in the case of transmitting signals from a base station MS1 100 to a mobile terminal 2 500. H₃₁ represents a channel gain in the case of transmitting signals from a base station MS1 100 to a mobile terminal 3 600. H₁₂ represents a channel gain in the case of transmitting signals from a base station MS2 200 to a mobile terminal 1 400. H₂₂ represents a channel gain in the case of transmitting signals from a base station MS2 200 to a mobile terminal 2 500. H₃₂ represents a channel gain in the case of transmitting signals from a base station MS2 200 to a mobile terminal 3 600. H₁₃ represents a channel gain in the case of transmitting signals from a base station MS3 300 to a mobile terminal 1 400. H₂₃ represents a channel gain in the case of transmitting signals from a base station MS3 300 to a mobile terminal 2 500. H₃₃ represents a channel gain in the case of transmitting signals from a base station MS3 300 to a mobile terminal 3 600.

The encoder for pre-alignment is designed as following Equation (8) to Equation (11):

a. span(H₂₃V₃)=span(H₂₁V₁) (8)

b. span(H₁₃V₃)=span(H₁₂V₂) (9)

c. span(H₂₂V₂)=span(H₂₃V_{P}) (10)

d. span(H₁₁V₁)=span(H₁₃V_{P}) (11)

The following Equation (12) is derived from Equation (10) and Equation (11), and the following Equation (13) and Equation (14) are derived from Equation (8) and Equation (9).

a. span(H₂₂⁻¹H₂₂V₂)=span(H₁₃⁻¹H₁₁V₁) (12)

b. span(H₂₁⁻¹H₂₃V₃)=span(V₁) (13)

c. span(H₁₂⁻¹H₁₃V₃)=span(V₂) (14)

The following Equation (15) and Equation (16) are derived through substitution and arrangement of Equations.

a. span(V₃)=span(EV₃) (15)

b. E=H₁₃⁻¹H₁₂H₂₂⁻¹H₂₃H₁₃⁻¹H₁₁H₂₁⁻¹H₂₃ (16)

In the Equation, V1 is determined by selecting only 2 columns of eigenvectors of E. Based on this, V1, V2, and Vp are determined as in following Equation (17) to Equation (22).

a. V₂=FV₃ (17)

b. V_{P}=HV₂ (18)

c. V₁=GV₃ (19)

d. F=H₁₂⁻¹H₁₃ (20)

e. G=H₂₁⁻¹H₂₃ (21)

f. H=H₂₃⁻¹H₂₂ (22)

The encoder can be designed by finding four variables from Equation (16), and Equation (20) to Equation (22).

According another embodiment of the present disclosure described above, the general node-base stations 100 and 200 provide signals to be transmitted by the general node-base stations 100 and 200 themselves and independent signals of the signals to be transmitted to the super node-base station 300. The super node performs pre-alignment on a different dimension from a dimension for transmitting a signal in an existing interference alignment scheme, and delivers a signal to be transmitted by other nodes through the pre-aligned dimension. The signals which have been pre-aligned and transmitted through the different dimension are aligned and received in the signal dimensions of the mobile terminals 100 and 200 corresponding to the general nodes. The mobile terminal 300 corresponding to the super node need not perform interference alignment on signals transmitted by the general nodes. It is the reason for this that the mobile terminal 300 performs decoding according to an interference cancellation coding scheme.

As described above, the use of the pre-alignment scheme is expected to have higher performance as compared to the case of not using the pre-alignment scheme. The reason for this is that the signal dimension of the mobile terminal 400 receives not only signals transmitted by the base station 100 but also signals transmitted by the base station 200 and to be received by the mobile terminal 500. The signals transmitted by the base station 200 are also received in the interference dimension of the mobile terminal 400. Accordingly, when the signals received in the signal dimension and the interference dimension of the mobile terminal 400 are combined with each other, reliability can be improved in decoding of the received signals. When the received signals are decoded properly, the effect of an interference to the received signals can be eliminated without errors, thereby improving overall reliability.

While the disclosure has been shown and described with reference to certain exemplary embodiments thereof, it will be understood by those skilled in the art that various changes in form and details may be made therein without departing from the spirit and scope of the disclosure as defined by the appended claims. The operation according to embodiments of the present disclosure may be recorded in a computer readable recording medium including program instructions for performing operation implemented in various computers. The computer readable recording medium may include a program command, a data file, and a data structure individually or a combination thereof. Further, the program command recorded in a recording medium may be specially designed or configured for the present disclosure or be known to a person having ordinary skill in a computer software field to be used. The computer readable recording medium includes Magnetic Media such as hard disk, floppy disk, or magnetic tape, Optical Media such as Compact Disc Read Only Memory (CD-ROM) or Digital Versatile Disc (DVD), Magneto-Optical Media such as floptical disk, and a hardware device such as ROM, RAM, or flash memory which are specifically configured to store and run program instructions. Further, the program command may include a machine language code created by a complier and a high-level language code executable by a computer using an interpreter. If all or some of a base station or a relay described above is implemented using a computer program, a recoding medium storing the computer program is included in the present disclosure. Therefore, the scope of the disclosure is defined not by the detailed description of the disclosure but by the appended claims, and all differences within the scope will be construed as being included in the present disclosure.

What is claimed is:

1. A mobile communication system comprising:
distributed small base stations including a super node and two or more general nodes,
wherein each of the general nodes are configured to process and transmit first data for transmission and output second data independent of the first data to the super node, and
wherein the super node is configured to receive the second data from the respective general nodes and process and transmit the second data and third data for transmission.

2. The mobile communication system of claim 1, wherein the super node is configured to encode the second data from the respective general nodes, and encode and transmit a result of the encoding and the third data in a signal dimension.

3. The mobile communication system of claim 2, wherein the super node includes:
an input unit configured to receive the second data from the respective general nodes;
a first encoding block configured to perform rate-splitting encoding on the second data received through the input unit;
a second encoding block configured to encode a result of encoding by the rate-splitting encoding block and the third data according to an interference cancellation coding scheme; and
a transmitter configured to transform an output of the second encoding block into a signal suitable for transmission through an antenna and transmit the signal,
wherein the transmitter is configured to process the signal to be transmitted to be received in a signal dimension of a corresponding terminal and to be received in interference dimensions of terminals other than the corresponding terminal.

4. The mobile communication system of claim 3, wherein the interference cancellation coding scheme includes Dirty Paper Coding (DPC).

5. The mobile communication system of claim 1, wherein each of the general nodes includes:
an output unit configured to output the second data to the super node;
an encoder configured to encode the first data; and
a transmitter configured to transform an output of the encoder into a signal suitable for transmission through an antenna and transmit the signal,
wherein the transmitter is configured to process the signal to be transmitted to be received in a signal dimension of a corresponding terminal and to be received in interference dimensions of terminals other than the corresponding terminal.

6. The mobile communication system of claim 5, wherein the encoder is configured to perform rate-splitting encoding on the first data.

7. A mobile terminal apparatus for a mobile communication system including distributed small base stations, the distributed small base stations including a super node and two or more general nodes, the mobile terminal apparatus comprising:
a signal dimension unit configured to reconstruct a signal based on data received from a corresponding node; and
an interference dimension unit configured to process data received from other nodes than the corresponding node as an interference,
wherein the data received from the super node includes second data independent of first data transmitted by the respective general nodes, and third data transmitted by the super node.

8. The mobile terminal apparatus of claim 7 wherein the mobile terminal apparatus corresponds with the super node, the mobile terminal apparatus further comprising:
a first receiver configured to receive transmission data from the super node;
a second receiver configured to receive transmission data from the general nodes; and
a decoder configured to perform decoding according to an interference cancellation decoding scheme and rate-splitting decoding on the data received by the first receiver.

9. The mobile terminal apparatus of claim 7, wherein the mobile terminal apparatus corresponds with the general node, the mobile terminal apparatus further comprising:
a first receiver configured to receive transmission data from a corresponding node;
a first decoder configured to perform rate-splitting decoding on the data received by the first receiver;
a second receiver configured to receive transmission data from nodes other than the corresponding node; and
a second decoder configured to perform decoding according to an interference cancellation coding scheme and rate-splitting decoding on the data received by the second receiver.

10. The mobile terminal apparatus of claim 8, wherein the interference cancellation decoding scheme includes Dirty Paper Coding (DPC).

11. A method for transmitting data in a super node of a mobile communication system, the mobile communicating system including distributed small base stations including a super node, and two or more general nodes, the method comprising:
receiving second data independent of first data for transmission from the respective general nodes; and
processing and transmitting the second data and third data for transmission.

12. The method of claim 11, wherein transmitting the second data and third data includes:
encoding second data from the respective general nodes in a signal dimension; and
encoding and transmitting a result of the encoding and the third data.

13. The method of claim 12, wherein transmitting the second data and third data includes:
receiving, second data from the respective general nodes;
performing rate-splitting encoding on the received second data;
encoding a result of the rate-splitting encoding and the third data according, to an interference cancellation scheme; and
transforming a result of the encoding according to an interference cancellation scheme into a signal suitable for transmission through an antenna and transmitting the signal, and
wherein the transmitted signal is received in the signal dimension of a corresponding terminal and in interference dimensions of terminals other than the corresponding terminal.

14. The method of claim 13, wherein the interference cancellation coding scheme includes Dirty Paper Coding (DPC).

15. A method for receiving data in a terminal for a mobile communication system, the mobile communicating system including distributed small base stations, the distributed small base stations including a super node and two or more general nodes, the method comprising:
reconstructing a signal based on data received from a corresponding node in a first dimension; and
processing data received from other nodes than the corresponding node as interference in a second dimension different from the first dimension,
wherein the data received from the super node includes second data independent of the first data transmitted by the respective general nodes, and third data transmitted by the super node.

16. The method of claim 15, further comprising:
when the terminal corresponds with the super node,
receiving transmission data from the super node;
receiving transmission data from the general nodes; and
performing decoding according to an interference cancellation decoding scheme, and rate-splitting decoding on the transmission data received from the super node.

17. The method of claim 15, further comprising:
when the terminal corresponds with the general node,
receiving transmission data from a corresponding node;
performing rate-splitting decoding on the data received from the corresponding node;
receiving transmission data from other nodes than the corresponding node; and
performing decoding according to an interference cancellation decoding scheme and rate-splitting decoding on the data received from the other nodes.

18. The method of claim 16, wherein the interference cancellation decoding scheme includes Dirty Paper Coding (DPC).
